(19) United States
(12) Patent Application Publication
(10) Pub. No.: US 2008/0205678 A1
(43) Pub. Date: Aug. 28, 2008

(54) Hearing apparatus with a special energy acceptance system and corresponding method

(75) Inventors: Mihail Boguslavskij, Coburg (DE); Thomas Hies, Singapore (SG); Kunibert Husung, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Audiologische Technik GmbH

(21) Appl. No.: 12/072,389

(22) Filed: Feb. 26, 2008

(30) Foreign Application Priority Data
Feb. 26, 2007 (DE) 10 2007 009 176.3

(51) Int. Cl. H04R 25/00

(52) U.S. Cl. 381/312

(57) ABSTRACT

Supplying energy into a hearing apparatus in order to charge its rechargeable battery is to be carried out by way of components, which take up as little space as possible. Components, which are mostly already present, are thus used for the energy supply. Energy is inductively injected into the coil of a receiver, into a data transmission coil or a telephone coil for instance. Alternatively, acoustic energy can also be injected via the receiver or microphone and converted there into electrical energy. Special components need then not be provided for the energy supply process.

### CROSS REFERENCE TO RELATED APPLICATIONS

This application claims priority of German application No. 102007009176.3 DE filed Feb. 26, 2007, which is incorporated by reference herein in its entirety.

### FIELD OF INVENTION

The present invention relates to a hearing apparatus with a signal processing device, an energy storage device, which can be charged and which energizes the signal processing device, and a converter device for converting an acoustic signal into an electrical signal or vice versa or alternatively a communication coil, for transmitting and/or receiving electromagnetic control signals or data signals. Furthermore, the present invention relates to a corresponding method for charging an energy storage device of a hearing apparatus. The term “hearing apparatus” is understood here to mean in particular a device which can be worn on the head, above all a hearing device, a headset, earphones and suchlike.

### BACKGROUND OF INVENTION

Hearing devices are portable hearing apparatuses which are used to supply the hard-of-hearing. To accommodate the numerous individual requirements, different configurations of hearing devices such as behind-the-ear hearing devices (BTE), in-the-ear hearing devices (ITE), e.g. including conch hearing devices or channel hearing devices (CIC), are provided. The hearing devices designed by way of example are worn on the outer ear or in the auditory canal. Furthermore, bone conduction hearing aids, implantable or vibrotactile hearing aids are also available on the market. In such cases the damaged hearing is stimulated either mechanically or electrically.

Essential components of the hearing devices include in principle an input converter, an amplifier and an output converter. The input converter is generally a receiving transducer, e.g. a microphone and/or an electromagnetic receiver, e.g. an induction coil. The output converter is mostly realized as an electroacoustic converter, e.g. a miniature loudspeaker, or as an electromechanical converter, e.g. a bone conduction receiver. The amplifier is usually integrated into a signal processing unit. This basic configuration is shown in the example in FIG. 1 of a behind-the-ear hearing device. One or a number of microphones 2 for recording the ambient sound are incorporated in a hearing device housing 1 to be worn behind the ear. A signal processing unit 3, which is similarly integrated into the hearing device housing 1, processes the microphone signals and amplifies them. The output signal of the signal processing unit 3 is transmitted to a loudspeaker and/or receiver 4, which outputs an acoustic signal. The sound is optionally transmitted to the ear drum of the device wearer via a sound tube, which is fixed with an otoplastic in the auditory canal. The power supply of the hearing device and in particular of the signal processing unit 3 is provided by a battery 5 which is likewise integrated into the hearing device housing 1.

Charging rechargeable batteries or batteries in a hearing device involves in many cases removing the rechargeable battery and/or battery from the hearing devices, plugging it into a charging device and charging it. After the charging process, the battery, which is generally very small and difficult to manage, is removed from the charging device and reinserted into the hearing device. An alternative charging method consists in leaving the rechargeable battery in the hearing device and charging it there using a wired charging system. To this end, corresponding metallic contacts are to be provided on the hearing device. These contacts are disadvantageous in that they normally protrude from the housing and are not flush therewith. Consequently, they can be easily contaminated.

The wireless transmission of energy to the hearing device is also known. The energy transfer for this can be carried out by means of electrical (capacitive), magnetic (inductive) and/or electromagnetic fields. This type of charging process requires at least one additional component in the hearing device, which converts the corresponding field into electrical energy.

An inductive method is used in most cases in order to wirelessly charge rechargeable batteries. The transmitter operates with a transmitting coil and the receiver of the energy likewise uses a coil to accept the energy. Coils of this type are relatively large, which, with hearing devices in particular runs counter to the ongoing aim of miniaturizing hearing devices.

The publication DE 199 15 846 C1 discloses an implantable system for rehabilitation of hearing loss. It comprises a wireless telemetric device for transmitting data between an implantable part of the system and an external unit as well as a power supply arrangement. The implantable unit may contain an energy receiving circuit for providing recharging energy on the implant side.

The publication DE 39 18 329 A1 also discloses a hearing device for electrical stimulation of the inner ear. It has external signal processing electronics which is supplied from a power supply in order to convert microphone signals into output signals which are suited to the inner ear stimulation. The signal processing electronics also wirelessly supplies a likewise implantable receiver circuit with operating energy.

### SUMMARY OF INVENTION

The object of the present invention thus consists in being able to transmit energy to a hearing apparatus, without requiring a lot of installation space in the hearing apparatus for this.

This object is achieved in accordance with the invention by a hearing apparatus with a signal processing device, an energy storage device, which can be charged and which supplies power to the signal processing device, and a converter device for converting an acoustic signal into an electrical signal or vice versa, with a charging circuit being connected between the converter device and the energy storage device so that energy, which is transmitted acoustically or electromagnetically to the converter device, can be supplied electrically into the energy storage device by way of the charging circuit.

Provision is also made in accordance with the invention for a method for charging an energy storage device of a hearing apparatus by transmitting acoustic energy to the hearing apparatus, converting the acoustic energy into electrical energy and supplying the electrical energy into the energy storage device.

It is thus advantageously possible to also use an acousto-electric and/or electro-acoustic converter, which is generally already present in every hearing apparatus, for the energy supply. There is thus no need for a special component for the energy supply, thereby reducing the overall volume of the hearing apparatus.

The converter device of the hearing apparatus according to the invention preferably includes a loudspeaker and/or receiver. The loudspeaker thus achieves the dual functionality of outputting sound and accepting energy.

The converter device can however also include a microphone. The microphone which is usually already present in hearing devices can thus also be used for acousto-electric energy conversion.

The converter device can be based on the electrodynamic principle. The advantage of this is that oscillations of a magnet produced by sound can be used to induce a current.

The converter device can however be based on a piezoelectric principle. According to this, piezoelectric microphones or loudspeakers can also be used for the energy conversion.

For the electromagnetic injection of energy into the converter device, said device should have a plastic housing. This can ensure that the energy to be supplied can be injected in an almost unattenuated fashion.

If the hearing apparatus comprises a communication unit for wireless transmission to another hearing apparatus for instance, it is advantageous if the plastic housing of the converter device has a first shielding against electromagnetic radiation above a first limit frequency, which amounts to at least 15 kHz and in particular at least 500 kHz for instance. Radiation from the converter device can thus be shielded, which would interfere with a transceiver unit, which typically transmits at 120 kHz (old devices) or 3.3 MHz (new devices).

The plastic housing can also have a second shielding against electromagnetic radiation below a second limit frequency, which amounts at the most to 20 kHz and in particular at the most to 12 kHz. In such cases it is possible for the receiver to influence the audio band by the hearing apparatus receiving audio signals by way of a telephone coil for instance. A combined shielding with the first and second shielding is carried out if necessary so that a shielding gap is produced in an area in which the energy transmission is to take place.

In accordance with a further embodiment, the hearing apparatus is realized as a hearing device with an external receiver, with the converter device including the external receiver. In this case, the receiver can be inserted into the charging stack of a charging device and a very efficient energy coupling can be ensured due to the small size of the receiver and/or the charging stack. A similar advantage is produced with small ITE and/or CIC devices.

According to the present invention, a charging device with a sound generator for generating an acoustic energy transmission signal, with which an afore-described hearing apparatus can be supplied with energy, is also proposed. This charging device can comprise a coupling element for the acoustic coupling of the acoustic charging device to the hearing apparatus. In particular, a tube can be provided which transmits an acoustic energy transmission signal into the carrying hook of a behind-the-ear hearing device for instance.

### BRIEF DESCRIPTION OF THE DRAWINGS

The present invention is now described in more detail with reference to the appended drawings, in which;

FIG. 1 shows a basic design of a hearing device according to the prior art;

FIG. 2 shows a hearing device with an inductive charging system according to the present invention;

FIG. 3 shows a hearing device with an acoustic charging system according to the present invention;

FIG. 4 shows a block diagram of a charging circuit for charging a battery by way of a receiver;

FIG. 5 shows a block diagram of a hearing device with an inductive charging device by means of a receiver winding and

FIG. 6 shows a diagram of a receiver motor with a charging coil.

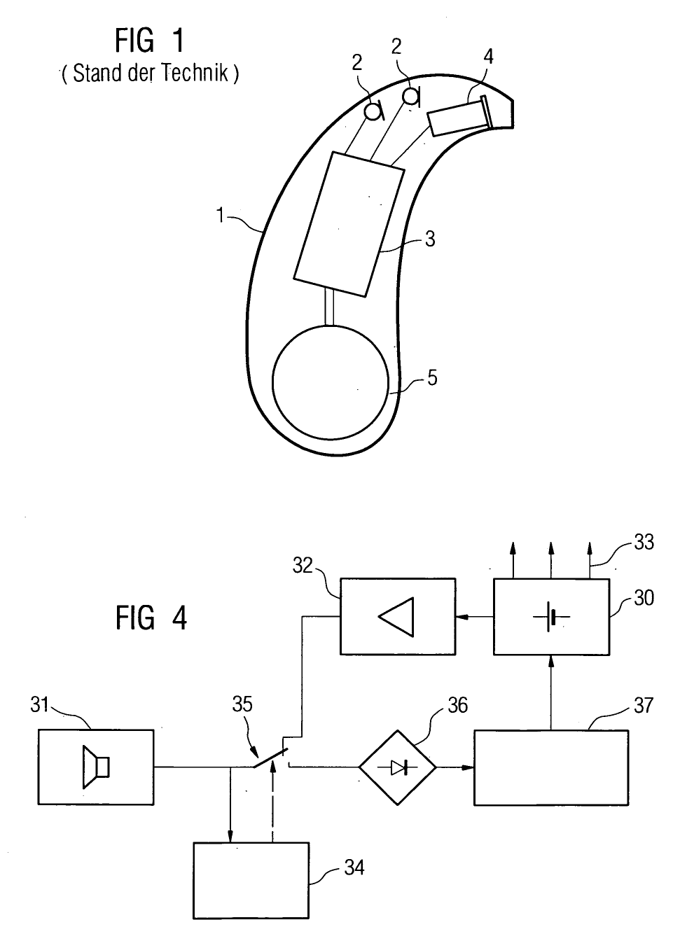

### DETAILED DESCRIPTION OF INVENTION

The exemplary embodiments illustrated in more detail below represent preferred embodiments of the present invention.

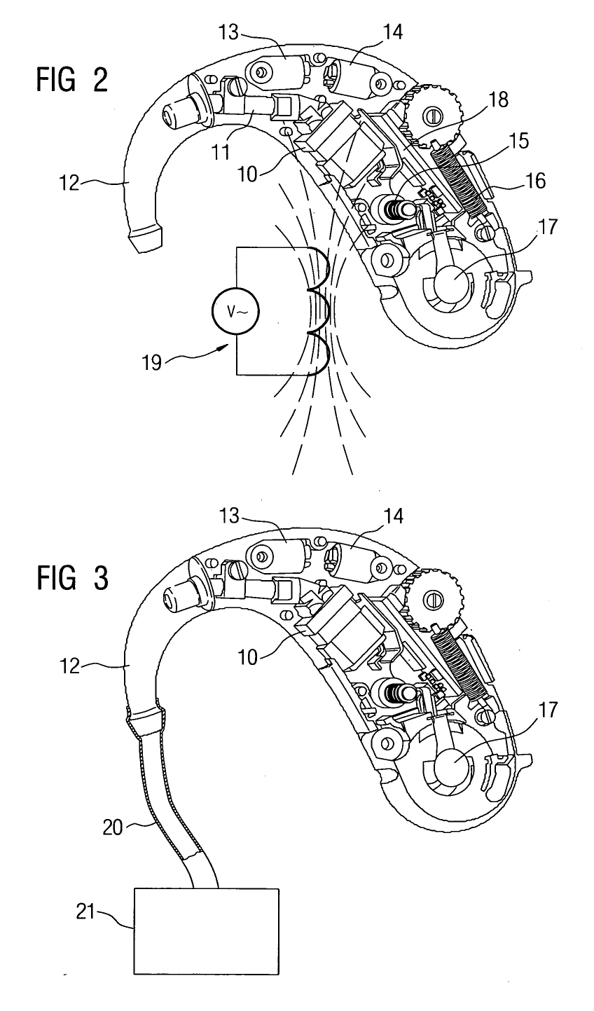

FIG. 2 shows a behind-the-ear hearing device, which usually comprises a receiver 10, which is acoustically coupled to a carrying hook 12 by way of a tubular coupling element 11, said carrying hook on its part conveying the output sound of the receiver 10 to the ear of the hearing device wearer by way of a receiver tube (not shown). The hearing device shown in FIG. 2 also has two microphones 13, 14, a communication coil 15 for data transmission in particular to a second hearing device, a telephone coil 16, a battery 17 and a printed circuit board 18 with a conventional signal processing unit.

An inductive charging device 19 is shown in FIG. 2 physically separated from the hearing device. This inductive charging device 19 generates a magnetic alternating field. This magnetic alternating field allows numerous components of the hearing device to interact. If the receiver 10 operates according to the electrodynamic principle for instance, it comprises an electrical coil, in which the magnetic alternating field can induce a current. This current can be used to charge the battery 17 with the aid of a charging circuit (compare FIG. 4).

Similarly, the microphones 14, 15 can obtain energy from the magnetic alternating field, if they operate according to the electrodynamic principle and comprise corresponding coils. Further coils for accepting energy may be the communication coil 15 as well as the telephone coil 16. In each case, a converter and/or a coil which is already present in the hearing device for another reason is used to obtain energy. A special coil for energy generation is thus not provided, although it could also be provided for instance as a loop antenna on the printed circuit board 18.

In the exemplary embodiment in FIG. 3, the same hearing device already shown in FIG. 2 is connected to an acoustic energy source 21 by way of a tube 20. This generates a sound as an energy carrier, which propagates over the tube 20 and the carrying hook 12 to the receiver 10. It is converted there into electrical energy. This can take place according to the electrodynamic principle or the piezoelectric principle for instance. Again, a suitable charging circuit (compare FIG. 4) is used to charge the battery 16 with the aid of the obtained electrical signal. In principle, the microphones 13, 14 can also be supplied with acoustic energy from the acoustic energy source 21. They also convert the acoustic energy into electrical energy in accordance with the respective principle.

In the case of energy generation with the aid of the receiver 10, this is used as an electro-acoustic converter as well as an acousto-electric converter in addition to its usual function. In the case of microphones 13, 14, the acousto-electric conversion principle is used for the energy generation, which is also used for its usual application to pick-up sound.

FIG. 4 shows a charging circuit by way of example, which is used to charge a battery 30, if the energy is obtained by way of the receiver 31 for instance. The battery 30 usually energizes the amplifier 32 of the hearing device. In addition to this, it also energizes other switching components, such as are shown in FIG. 4 with the arrows 33. The output signal of the amplifier 32 is fed to the loudspeaker and/or receiver 31.

In order to generate energy, the receiver 31 is operated in reverse, which is why its connection is monitored by a detector 34. This determines a charging signal on the basis of a special signal sequence for instance. Consequently, it interrupts the signal path between the amplifier 32 and the receiver 31 with a switch 35 and conveys the charging signal from the receiver 31 to a rectifier 36. The output signal of the rectifier 36 is fed to a voltage regulator 37, which for its part charges the battery 30 with suitable voltage. A charging signal can be detected and tapped in this way from each converter. The components 34 to 37 of the charging circuit are either likewise already present in the hearing device or they only take up only relatively little space on the printed circuit board 18 for instance, if they are to be provided in addition.

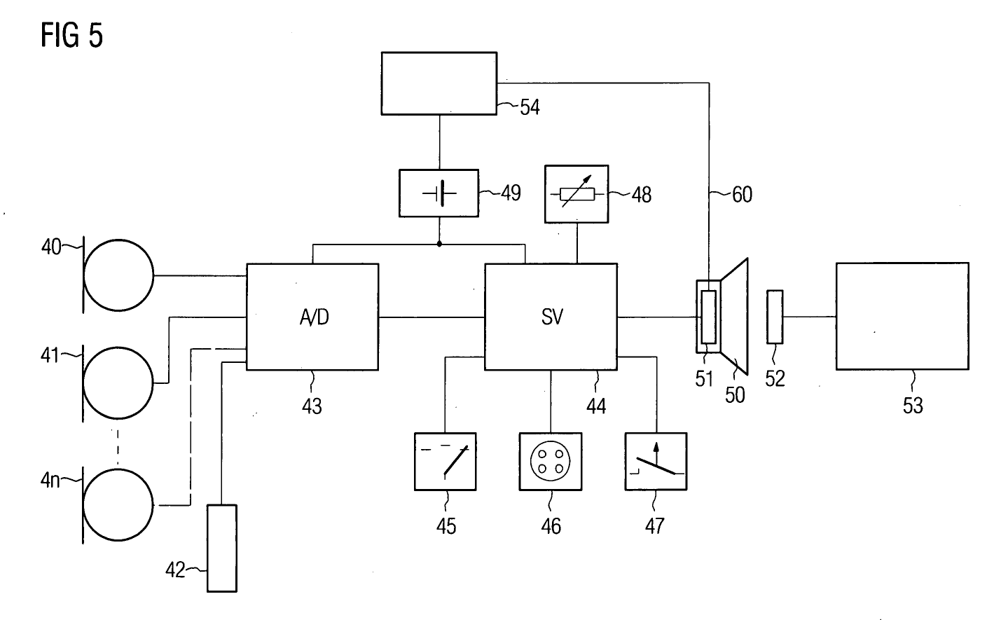

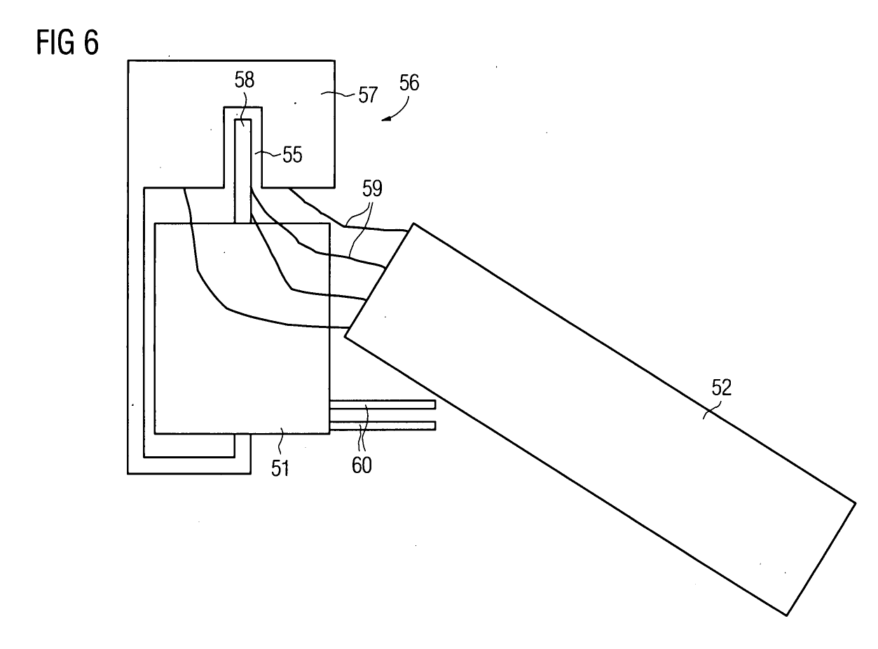

A further exemplary embodiment of a hearing apparatus according to the invention is shown in FIGS. 5 and 6. In this embodiment FIG. 5 shows a block diagram of the essential components of a hearing device as well as an inductive charging device. The hearing device has a plurality of microphones 40, 41, . . . , 4n. The microphones are used in each instance as an input unit for acoustic signals. A telephone coil 42 is also provided as an input unit for the preprocessing unit 42. The preprocessing unit 43 generally consists of a preamplifier with an A/D converter and a voltage controller. The output signal of the preprocessing unit 43 is fed to a digital signal processor 44 with a clocked output stage. The digital signal processor 44 can be controlled by a program switch 45, a programming socket 46, a situation key 47 and a VC actuator 48. A rechargeable battery 49 energizes the preprocessing unit 43 and the digital signal processor 44. The output signal of the digital signal processor 44 is fed to a receiver 40. This has a plastic housing with or without special shielding. The receiver 50 operating according to the electrodynamic principle also has an electric coil 51. It is not only used to convert the electrical signals from the signal processor 44 into corresponding magnetic fields, but also vice versa to convert inductively received signals into electrical signals. These inductive signals originate from a transmitting coil 52 of an inductive charging device 53. The energy transmitted by the charging coil 52 to the coil 51 of the receiver 50 is transmitted to a charging electronics 54 of the hearing device in the form of an electrical signal. It is changed there into a suitable form and fed into the battery 49.

Alternatively, the microphones 40, 41, . . . , 4n could also be used for energy transmission if they operate according to the electrodynamic principle. The charging coil 52 must then transfer the energy to the microphones 40 to 4n and the microphones 40 to 4n must be correspondingly connected to the charging electronics 54.

The function of the hearing aid device is described in more detail below, into the receiver winding of which energy is inductively injected. As is known, a transformer is required for magnetic energy transmission. The primary winding is formed here by the charging and/or transmitting coil 52 of the charging device 53. The secondary winding is realized by the magnetic circuit of the receiver 50. A receiver housing which is usually made of metal is however troublesome here. It is typically used as a magnetic shielding of the receiver magnetic field and thus also prevents the penetration of external magnetic fields. If a receiver is however produced with a plastic housing, this is not only advantageous in terms of its cost-effective manufacture but also in terms of the inductive energy transmission which takes place unimpeded. In particular, a plastic receiver of this type can be used advantageously for hearing aid devices with an external receiver.

A simple charging device 53 with a small bay for insertion of the acoustic converter can be used to provide energy. In the case of an external receiver, this is plugged into the bay. ITE and/or CIC devices can be introduced completely into a bay of this type for charging purposes. With BTE hearing devices, the receiver part or the microphone part (depending on which converter is used for the energy supply) is inserted into the bay.

FIG. 6 shows the principle of the inductive supply with the aid of a receiver motor and a charging coil. The plastic housing and the membrane of the receiver are not shown. The magnetic energy is injected into an air gap of the magnetic circuit 56 of the receiver motor by way of the charging coil 52, which is realized here as an air coil and shows the primary coil. This magnetic circuit 56 generally consists of a laminated core 57, optionally with magnets (not shown) and a magnetic tongue 58 connected thereto. This is moved with the aid of the coil 51 and moves a membrane (not shown) of the receiver 50. Field lines 59 indicate a magnetic field, which is injected into the air gap 55 and/or the magnetic circuit 56 by the charging coil 52. The corresponding magnetic flux in the magnetic circuit 56 inducts an electric current in the coil 51, which is conveyed to the charging electronics 54 by way of the connecting leads 60.

To ensure that the electrical energy can be injected into the receiver 50 in as lossless a manner as possible, said receiver has a plastic housing. This plastic housing can be provided with an electrical conductive layer, in order to ensure an electromagnetic shielding. Sensitive assemblies (transceivers for wireless data transmission between hearing devices and/or for receiving audio data for instance) in the hearing aid device are thus not disturbed.

In hearing systems with telephone coils, a magnetic receiver shielding is essential for a data transmission to be at all possible in the audio range. It is thus necessary for instance to shield the receiver in the transmission range below 20 kHz so that audio data from the telephone coil of the hearing aid device can be inductively received in the audio range in an interference-free fashion. If necessary, the limit frequency of this shielding can also lie below 20 kHz, e.g. at 12 kHz or 10 kHz. The inductive energy transmission can then take place in a frequency range above this limit frequency, in other words above 12 kHz or 20 kHz, e.g. at 50 kHz, for instance.

If a broadband data transmission is to be enabled between two hearing devices at 3.3 MHz in the hearing system, the receiver needs to be equipped with a corresponding HF shielding. The shielding then has a limit frequency of 500 kHz for instance so that it can not be penetrated by radiation with a frequency lying thereabove and/or can only be penetrated by heavily attenuated radiation. This limit frequency can however also be lower, for instance at 100 kHz or 15 kHz, if a lower lying frequency is used for the energy transmission. If necessary, this shielding can also be combined with the afore-mentioned shielding in the audio range so that a frequency clearance only exists only for the energy transmission, in which frequency clearance effective energy can be transmitted to the receiver and/or the otherwise shielded converter. Standard BTEs can also be realized with this charging technology by suitably adjusting the housing shielding.

The inductive supply of energy into rechargeable batteries in hearing aid devices allows devices to be charged in a user-friendly fashion on a daily basis with a corresponding charging station. As no additional charging coil is needed on the secondary side in accordance with the invention, the corresponding devices can be built significantly smaller despite the use of this inductive charging technology. It is thus also possible to inductively charge even small ITE and CIC devices by using the dual function of the receiver and/or microphone.

Some advantages also result in respect of the charging devices, since they can be designed in a relatively simple fashion. They only have one charging bay for instance, into which the whole hearing device or only the external receiver of the hearing device is placed. In this process, the charging bay can be relatively independent of the hearing device housing form.

1.-12. (canceled)

13. A hearing apparatus, comprising:
a signal processing device;
a chargeable energy storage device which that supplies power to the signal processing device;
a converter device that converts an acoustic signal into an electrical signal or vice versa; and
a charging circuit connected between the converter device and the energy storage device such that energy, which is acoustically or electromagnetically transmitted to the converter device is electrically supplied to the energy storage device via the charging circuit.

14. The hearing apparatus as claimed in claim 13, wherein the converter device includes a loudspeaker.

15. The hearing apparatus as claimed in claim 13, wherein the converter device includes a microphone.

16. The hearing apparatus as claimed in claim 13, wherein the converter device is being based on an electrodynamic principle.

17. The hearing apparatus as claimed in claim 13, wherein the converter device is based on a piezoelectric principle.

18. The hearing apparatus as claimed in claim 13, wherein the converter device comprising a plastic housing.

19. The hearing apparatus as claimed in claim 18, wherein the plastic housing comprises a first shielding against electromagnetic radiation above a first limit frequency, which is at least 15 kHz.

20. The hearing apparatus as claimed in claim 19, wherein the first limit frequency is at least 500 kHz.

21. The hearing apparatus as claimed in claim 18, wherein the plastic housing comprises a second shielding against electromagnetic radiation below a second limit frequency, which is at the most to 20 kHz and in particular at the most to 12 kHz.

22. The hearing apparatus as claimed in claim 21, wherein the second limit is at the most 12 kHz.

23. The hearing apparatus as claimed in claim 19, wherein the plastic housing comprises a second shielding against electromagnetic radiation below a second limit frequency, which is at the most to 20 kHz and in particular at the most to 12 kHz.

24. The hearing apparatus as claimed in claim 13, wherein includes with an external receiver and the converter device includes the external receiver.

25. A charging device comprising:
a sound generator for generating an acoustic energy transmission signal with which a chargeable energy storage device of an hearing apparatus is supplied with energy,

26. The charging device as claimed in claim 25, includes a coupling element for the acoustic coupling of the charging device to the hearing apparatus.

27. A method for charging an energy storage device of a hearing apparatus, comprising:
transmitting acoustic energy to the hearing apparatus;
converting the acoustic energy into electrical energy; and
supplying the electrical energy to the energy storage device.
